(19) United States
(12) Patent Application Publication
(10) Pub. No.: US 2010/0050946 A1
(43) Pub. Date: Mar. 4, 2010

(54) Butterfly Rearing Apparatus and Method

(76) Inventor: Edward Tsyrlin, Victoria (AU)

Correspondence Address: DONN K. HARMS;PATENT & TRADEMARK LAW CENTER, SUITE 100, 12702 VIA CORTINA, DEL MAR, CA, 92014, US

(21) Appl. No.: 12/553,869

(22) Filed: Sep. 3, 2009

Related U.S. Application Data
(60) Provisional application No. 61/094,016, filed on Sep. 3, 2008.

(51) Int. Cl. A01K 29/00

(52) U.S. Cl. 119/6.5

(57) ABSTRACT

A butterfly rearing kit having a housing formed substantially of air permeable fabric derived of fibers from a plant such as sinamay. An internal cavity of the housing is marked with a target for mounting a chrysalis in an elevated position from the bottom of the housing. An area of the fabric surrounds the mounting position such that an emerging butterfly has an unobstructed space to extend its wings for drying. The drying is aided by the airflow through the material. Forming the material from sinamay provides an attractant to the butterfly to lite in the area of unobstructed space and avoid falling or moving to the bottom of the housing.

This application claims priority to U.S. Provisional Patent Application No. 61/094,016 filed on Sep. 3, 2008 and incorporated herein in its entirety by reference.

### BACKGROUND OF THE INVENTION

1. Field of the Invention

The present invention relates to the breeding and observation of butterflies. More particularly it relates to a device and method employing a unique plant-based fabric construction for the enclosures, provided to users, for housing a butterfly larva or butterfly chrysalis during its metamorphosis into a butterfly.

2. Prior Art

The observations of butterfly larva forming in a chrysalis and subsequent viewing of a butterfly emerging from that chrysalis is both interesting and educational. A number of butterfly rearing kits have been developed and marketed, both as gifts for a person and for use in school science projects. Conventionally, such kits include either a clear plastic container or a housing container in the form of a plastic tent or cardboard box with a thin plastic sheet window. The user is afforded an ongoing view of the developing butterfly through a wall or clear plastic window engaged with the housing.

To aid in viewing by the user, and the development of the butterfly on emerging from its chrysalis, some such conventional rearing devices provide for a position for the chrysalis to be easily viewed by the user during its development. Deployed by a user with the larva properly positioned therein, the housing with viewing window and properly positioned chrysalis, provides the user with an ongoing observation of the ongoing metamorphosis of the larva.

After a predictable time frame, which is usually a day or two, a butterfly may be observed emerging within the housing by a user. Normally, the butterfly, in a natural state of its emerging from the chrysalis, will have wings that are compacted or folded due to the cramped quarters provided within the chrysalis. The wings are also generally damp from their restricted stay within the chrysalis.

To enable itself to fly, the emerged butterfly will extend its wings for a duration of time sufficient to unfold them and also to dry them such that they are functional. This is a very important step in the natural emergence of a healthy butterfly from the damp and cramped quarters of the chrysalis. Should the butterfly be unable to properly extend and dry their wings, and to find sufficient air circulation to dry them, permanent damage will normally result. As a general rule, once the butterfly has completely emerged and can fly, it is released into the environment by opening the securable top wall of the enclosure.

Conventionally available butterfly rearing kits generally employ some form of extruded or otherwise formed fabric to form a viewing aperture adapted to hold the butterfly larva for observation during development. Such fabric material is best formed to be somewhat sheer to enable easy observation of the ongoing metamorphosis by the user through the viewing window.

However, most such kits either employ extruded solid fabrics or woven type fabrics of a tight weaver and which use a synthetic yarn such as polyester or nylon or vinyl coated synthetic scrim. These synthetic fabrics mounted in the viewing aperture, along with synthetic plastics or cardboard forming walls, form a container or housing that is employed by the user to host the developing butterfly for observation.

Some kits are known to employ silk or organza for the yarn woven or knitted to form the viewing aperture, or a sidewall for viewing. However, many employ additional walls that lack sufficient air flow and such fabric, when employed, is much more expensive than synthetic fabrics, which are more widely employed. Further, the use of these fabrics along with plastic or cardboard walls produce an enclosure with air flow and other problems similar to those of using purely synthetic fabrics for the viewing wall or aperture.

A majority of the problems, such containers providing a proper housing for the developing butterfly, occur due to the employment of the plastic and cardboard walls which limit air flow as well as viewing. These are compounded by the concurrent employment of viewing apertures using plastic or tightly woven fabrics as inserts to the formed aperture which limit both viewing and air flow.

An additional problem of conventional butterfly enclosures is that conventional structures are formed of coated or synthetic fabrics which will not absorb fluids and water. Such enclosures also tend to have a sterile or manufactured appearance about them aesthetically.

Such conventionally employed synthetic fabrics further tend to have a plastic odor to them when unpacked and during use. The smell of plasticizers venting from the fabric forming the enclosure, in close proximity to the user's eyes and nose, tend to inhibit use of the enclosures and this is especially true of children.

A functional problem of conventional butterfly rearing enclosures occurs due to the failure in such enclosure housing to provide an elevated perch for the emerged butterfly. In the wild, emerging butterflies are generally in a chrysalis engaged in elevated positions. On emerging in the elevated position the butterfly is presented with surrounding space which provides good air flow for and space for the butterfly to stretch and dry their wings. Conventional butterfly housings generally provide the housing and a chrysalis which is positioned by the user within the housing so it may be viewed which may be on the floor of the enclosure. As noted, the ability for the emerging butterfly to find a suitable position, with both space and airflow to extend and dry its wings, is critical in the time duration after they emerge from the cocoon. The lack of a specific perch elevated for airflow and stretching space, along with the unnatural appearance and odor of such conventional enclosures, can be deadly to the butterfly which emerges on the floor of the enclosure, and demoralizing to a user such as a child.

To properly unfold its wings at this critical juncture, the emerging butterfly must find adjacent room and airflow to unfold its wings and cannot fly. If it finds a proper position on exiting the chrysalis, the butterfly then must spend at least an hour sitting in the open air to extend and dry its wings. If for some reason the butterfly fails to find an adequate elevated and airy position for this important period of development, it will quite likely fail to properly develop which for the butterfly and user, is a devastating development.

Thus, there is a continuing need for improved butterfly rearing containers. Such containers should provide for easy viewing by users and should not dissuade such viewing with odorous plastics and synthetics. Such devices need to be relatively sturdy, yet concurrently permit easy observation of the ongoing natural process through the provision of a viewing window or wall. Such an improved device, rather than using cardboard or solid fabrics which inhibit a full flow of air though the interior chamber, should be formed of a porous, natural fabric, thereby providing adequate airflow. Finally, such an improved rearing device should provide a mount for the chrysalis, which is elevated, and employ soft woven fabric surrounding the mount such that the newly emerging butterfly can easily grasp the fabric surface from this airy perch during the critical minutes after emerging from the cocoon. Finally, such a container should employ such an inexpensive natural woven material to render the eventual cost of the device sufficiently inexpensive to encourage widespread use.

### SUMMARY OF THE INVENTION

The device and method herein disclosed and described achieves the above-mentioned goals and objects, through the provision of chrysalis kit which employs sidewalls formed of a see-through woven or knitted, spun bonded or otherwise engaged material. The chrysalis is either adhered to an elevated position on a sidewall or top wall formed of such fabric or the user is provided a means to securely mount the chrysalis in the elevated position surrounded by air-permeable and easy to grip fabric.

Instead of cardboard, vinyl or coated scrims, which are used in conventional enclosures, the device herein employs a heretofore unused fabric in the field of butterfly rearing enclosures. Experimentation has found that a plant-based fabric named sinamay provides a significant improvement in both air flow and viewing due to its sheerness and ability to allow air circulation. Sinamay is thus the preferred use to form all of the walls of the enclosure and to define an internal development chamber for the butterfly.

While normally used to form hats and the like from larger fibers and leaf sections, sinamay when processed to yield fibrous material which is spun into yarn for the woven or otherwise formed enclosure side walls and top and bottom, provides an enclosure structure far superior to conventional vinyl coated nylon and synthetic yarns. The sinamay employed for the invention herein is spun into yarn and thread using fibers harvested from the abaca plant, which appears very similar to the banana plant, and is grown mainly in Philippines.

Additionally, because it is a natural material harvested from an abaca plant which exists outdoors, sinamay formed fabric does not have an unnatural or synthetic odor, and the noted negative aspects of synthetic fibers which inhibit air flow. This eliminates the plastic and artificial smells suffered by conventional enclosures which are confusing and detrimental to emerging butterflies seeking an airy perch in a natural habitat.

The use of sinamay thus provides a natural fiber emulating the natural environment of the emerging butterfly. Combined with a defined perch for the chrysalis, and surrounding it with a natural and easily gripped fabric adjacent to the chrysalis, provides a means to attract the emerging butterfly to a position perfect for it to unfold and dry its wings for the duration of time needed. Because the sinamay fabric, as noted, surrounds the chrysalis on the side wall or top wall, and is open and airy, the attracted butterfly is properly provided an attractive perching position in the housing during the wing-drying and expansion stage to properly develop.

This non-deterrence, proper positioning, and means for attraction of the emerging butterfly thus overcomes the noted shortcomings of synthetic fibers and solid walls of cardboard. Further, being spun from a naturally occurring plant fiber from the abacas plant, the formed woven or knitted walls of the device provides excellent footing to the new butterfly which itself is adapted to seek an elevated plant or natural material on which to perch.

Rather than employing cardboard, vinyl, or plastic sheeting for walls or support of upright walls of the enclosure, the device employs sinamay in a sheer weave to form a very sheer fabric for all of the walls of the formed enclosure. In order to maintain the cube or other shape of the structure, a skeletal system formed of small sections of stiffer fabric, wood, or sewn seams, is provided. However, the majority of all of the walls of the enclosure are formed of the woven sinamay which significantly increases the viewing area, and viewing angles for users wishing to watch the housed butterflies from a conventional device just employing screened window areas. The increased viewing areas and angles thereby provide an easy and unobstructed observation of the chrysalis, and the newly emerged butterfly, during the ongoing metamorphosis, at angles and from viewpoints not currently provided.

In addition to butterfly, the device herein formed of sinamay and stiffeners or skeletal components necessary to maintain its shape, can be used to grow caterpillars and other insects which morph into adults. The housings, so formed, provide a protected interior for holding cut plants for the housed caterpillars for food for educational life cycle kits.

As noted, the device also provides a mounted or mountable chrysalis to the user in the kit. In the preferred mounting position elevated on a sidewall, the chrysalis is glued, or engaged to a small wire hook using a drop of adhesive such as hot glue. The wire employed is generally soft florist wire as it can come in different colors. An earring hook may also be employed to suspend the chrysalis. The chrysalis may also be glued directly to the fabric, thread or other means of securement to the fabric in an elevated position provided. This insures the hatching butterfly is provided a wall surface immediately surrounding the chrysalis which is airy and easy for the butterfly to grasp for a duration.

The sidewalls formed of sinamay and any stiffeners or slim structural supports are formed in a preferred mode, such that the enclosure is rendered to the shape of a cube with one side of the opening formed as a door so as to allow the user to remove the butterfly or service the interior. The door is securable using a loop-engaging mount such as a wooden button. While the cube shape is a particularly favored embodiment, due to the easy viewing, through the planar panels and maximizing of air flow, the shape and size may vary and the sidewalls forming the structure may be of different sizes and a variety of forms such as a cylinder or pyramid or globe. Different shapes will require that the door portion be moved such that it may be hooked appropriately.

In use, once ordered, the kit is best mailed to customers using overnight Express Post or overnight courier to minimize the time in transit. The enclosure formed of the sinamay panels forming all of the sidewalls tends to maintain its cube shape in transit with the chrysalis packaged inside it.

The chrysalis is provided already attached and protected with a removable shield, or is positioned inside a plastic vial or sealed cup with a lid and is best cushioned by cotton wool. The plastic vial or a small plastic cup with the chrysalis is held against the lid of the enclosure by paper in suspension to protect it from possible knocks during transit. More than one chrysalis can be included with the cube of larger size. One preferred size of the device is a 12×12×12 cm cube, which has an option of two chrysalises, and larger sizes would allow more chrysalises to be housed and observed within the internal area formed by the sidewalls.

Instructions for deployment and use are provided on a label attached to the sidewall or top wall of the cube using means of adhesive attachment such as a piece of double sided sticky tape. Target positions for the attachment may also be provided to aid the user in proper placement. The label instructs the user how to hook the chrysalis to the top of the cube and directs the user to release the butterfly in 2-3 days after the emergence. The butterfly legend is written on the top panel of the label. The inside of the label has more detailed information about the butterfly metamorphosis and distinction between the chrysalis, pupa and cocoon.

The device may also be sold as a chrysalis kit in retail stores, however, generally without a chrysalis, which would be forwarded upon the user sending a voucher sold with the kit.

With respect to the above description, it is to be understood that the invention is not limited in its application to the details of construction and to the arrangement of the components in this specification or illustrated in the drawings. The device and method herein described are capable of other embodiments and of being practiced and carried out in various ways which will be obvious to those skilled in the art upon reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed chrysalis kit. It is important, therefore, that the claims and disclosure herein be regarded as including such equivalent construction and methodology insofar as they do not depart from the spirit of the present invention.

It is an object of this invention to provide a chrysalis kit having sidewalls and top walls formed of a natural fabric which will not deter emerging butterflies from landing and provide a good foothold to attract them.

It is an additional object of this invention to provide a chrysalis kit that employs such sidewalls and top walls formed of natural fibers which are also easy to see through and which allow for a cool and natural airflow through the housing.

These together with other objects and advantages which become subsequently apparent reside in the details of the construction and operation as heretofore described with reference being had to the accompanying drawings forming a part thereof, wherein like numerals refer to like parts throughout.

### BRIEF DESCRIPTION OF DRAWING FIGURES

FIG. 1 depicts the device having a top wall and sidewalls formed of the preferred sinamay fabric and the chrysalis engaged to a defined elevated position on a sidewall.

FIG. 2 depicts the sinamay fabric in a cut-away showing the internal cavity of the housing and the weave resulting in a mesh adapted for perching upon by a hatched butterfly.

### DETAILED DESCRIPTION OF THE PREFERRED EMBODIMENTS OF THE INVENTION

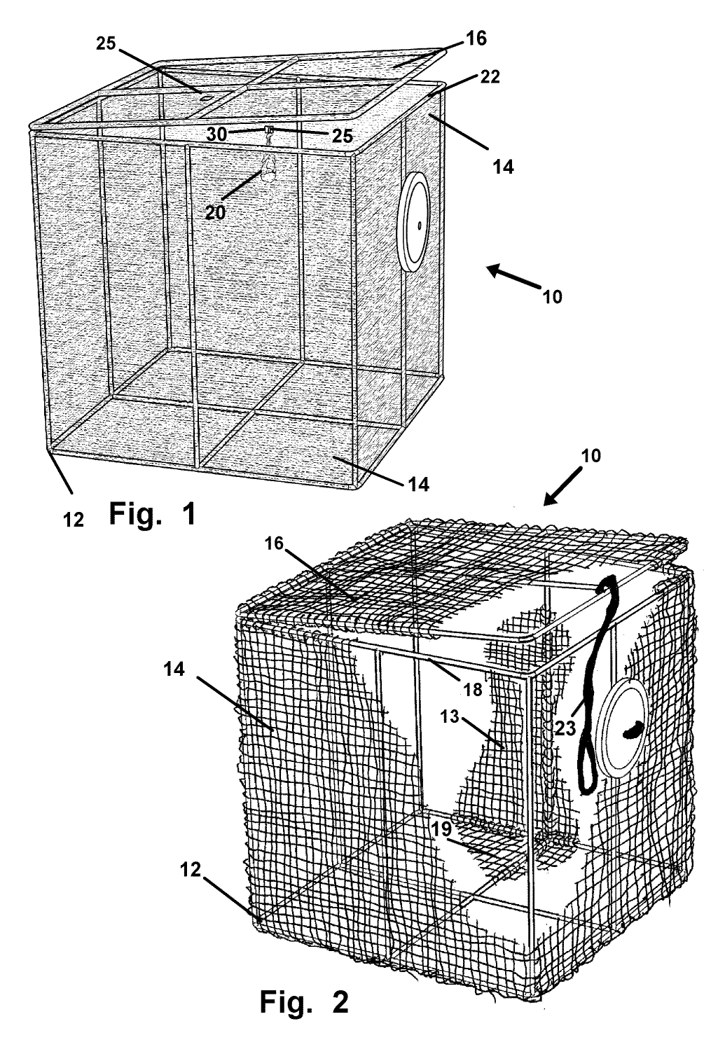

Referring now to all of the drawings in FIGS. 1-2, wherein similar components are identified by like reference numerals, the butterfly hatching kit device 10 is depicted in FIG. 1 which shows a perspective view. The device 10 which is provided in a kit form and shows the housing 12 in a favored cube shape with sidewalls 14 and a sealable top wall 16 preferably formed of a plant derived fabric which is woven or knitted.

Particularly preferred, due to is airflow and other enhancement, is sinamay fabric 13 operatively engaged with stiffeners 18. As noted, sinamay has numerous benefits to the formed housing 12 and its natural interaction with an emerging butterfly, which will be attracted to it. Stiffeners 18 may be employed such as heavy seams, such as using an over lock stitch, thing wire, plastic members, or other form-retaining components which are woven or seamed or otherwise engaged to the sidewalls 14 and top wall 16 of the fabric to maintain the shape.

The top wall 16 is sealable to a closed position against the elevated edge 22 of the connected surrounding sidewalls 14. This allows for a closed enclosure for the emerging butterfly. It may be opened to release the butterfly by lifting the top wall 16 after releasing a means to maintain it against the edge 22 which in this case is lace 23 but could be a latch or the weight of the top wall 16 or other means to secure the top wall 16 in the closed position.

A chrysalis 20 may be provided with means to attach it to a defined elevated position 25 on a sidewall 14 or top wall 16 such that a butterfly emerging will be surrounded by sinamay fabric 13 preferably on all sides to emulate a natural emergence where the butterfly will encounter plants. The defined position 25 is, as noted, preferably elevated above the bottom of the housing and provides room for the emerging butterfly to spread and dry its wings. Central portions of one or more sidewalls 14 and the top wall 16 will preferably be marked with a target, thereby providing a means to determine a proper mount for the chrysalis in the elevated position surrounded by air permeable and easy to grip fabric 13. This will help overcome the inexperienced user's mistaken assumption that the floor 19 of the housing 12 is the proper position. Means for attachment may also be provided with the kit such as glue, double-sided tape 30, or some type of physical restraint, such as a thread or strap, which may be engaged to the elevated position 25 which is marked on one or both of the side walls 14 and the top wall 16, so the user may view it easily. Alternatively, the chrysalis 20 may be pre-attached in the elevated position 25 at the factory and subsequently provided to the user.

While all of the fundamental characteristics and features of the chrysalis kit have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A butterfly rearing kit, comprising:
a housing;
said housing having a bottom wall;
said housing having a sidewall extending from a connection as a first sidewall edge, to a second sidewall edge;
said housing having a top wall removably engageable with said sidewall to a position opposite said bottom wall;
an internal cavity defined by the area between said bottom wall, said side wall, and said top wall;
a target, said target defining a mounting position within said internal cavity for engagement of a chrysalis, said target being viewable through at least one of said side wall, said bottom wall, and said top wall;
said mounting position being elevated above said bottom wall at a position upon one or both of said side wall and said top wall;
said chrysalis, engaged substantially at said mounting position, being viewable during a gestation period;
said mounting position surrounded by fabric, said fabric being air permeable; and
said fabric surrounding said mounting position having an unobstructed area, said unobstructed area being sufficient to allow a butterfly emerging from said chrysalis and to lite therein, a space to fully spread its wings while perched adjacent to said mounting position, whereby said butterfly emerging from said chrysalis engaged substantially at said mounting position can spread its wings unobstructed for a duration of time during which air communicating through said fabric provides means to aid in a drying of said wings.

2. The butterfly rearing kit of claim 1 additionally comprising:
said fabric formed of sinamay; and
said sinamay emulating a natural attraction of plants to said butterfly emerging from said chrysalis thereby providing a means to attract said butterfly to lite upon said fabric within said unobstructed area, for said duration of time, and to thereby provide a means to dissuade said butterfly from falling or liting upon said bottom wall.

3. The butterfly rearing kit of claim 1 additionally comprising:
said top wall, said sidewall, and said bottom wall formed of said fabric.

4. The butterfly rearing kit of claim 3 additionally comprising:
said fabric formed of sinamay; and
said sinamay emulating a natural attraction of plants to said butterfly emerging from said chrysalis thereby providing a means to attract said butterfly to lite upon said fabric within said unobstructed area, for said duration of time, and to thereby provide a means to dissuade said butterfly from falling or liting upon said bottom wall.

5. The butterfly rearing kit of claim 1 additionally comprising:
said top wall, said bottom wall, and said side wall, all formed of said fabric; and
stiffeners engaged with said fabric to define a shape to said housing.

6. The butterfly rearing kit of claim 2 additionally comprising:
said top wall, said bottom wall, and said side wall, all formed of said fabric; and
stiffeners engaged with said fabric to define a shape to said housing.

7. The butterfly rearing kit of claim 3 additionally comprising:
stiffeners engaged with said fabric to define a shape to said housing.

8. The butterfly rearing kit of claim 4 additionally comprising:
stiffeners engaged with said fabric to define a shape to said housing.

9. The butterfly rearing kit of claim 1 additionally comprising:
said fabric formed of yarn derived from plants; and
said yarn forming said fabric emulating a natural attraction of plants to said butterfly emerging from said chrysalis thereby providing a means to attract said butterfly to lite upon said fabric within said unobstructed area, for said duration of time, and to thereby provide a means to dissuade said butterfly from falling or liting upon said bottom wall.

10. The butterfly rearing kit of claim 2 additionally comprising:
said fabric formed of yarn derived from plants; and
said yarn forming said fabric emulating a natural attraction of plants to said butterfly emerging from said chrysalis thereby providing a means to attract said butterfly to lite upon said fabric within said unobstructed area, for said duration of time, and to thereby provide a means to dissuade said butterfly from falling or liting upon said bottom wall.

11. The butterfly rearing kit of claim 3 additionally comprising:
said fabric formed of yarn derived from plants; and
said yarn forming said fabric emulating a natural attraction of plants to said butterfly emerging from said chrysalis thereby providing a means to attract said butterfly to lite upon said fabric within said unobstructed area, for said duration of time, and to thereby provide a means to dissuade said butterfly from falling or liting upon said bottom wall.

12. The butterfly rearing kit of claim 1 additionally comprising:
said top wall having an open position with said fastener disengaged, and a closed position with said fastener engaged; and
said top wall in said open position providing means to access said cavity and an opening for said butterfly as a means to exit said cavity after said duration of time.

13. The butterfly rearing kit of claim 2 additionally comprising:
said top wall having an open position with said fastener disengaged, and a closed position with said fastener engaged; and
said top wall in said open position providing means to access said cavity and an opening for said butterfly as a means to exit said cavity after said duration of time.

14. The butterfly rearing kit of claim 3 additionally comprising:
said top wall having an open position with said fastener disengaged, and a closed position with said fastener engaged; and
said top wall in said open position providing means to access said cavity and an opening for said butterfly as a means to exit said cavity after said duration of time.

15. The butterfly rearing kit of claim 4 additionally comprising:
said top wall having an open position with said fastener disengaged, and a closed position with said fastener engaged; and
said top wall in said open position providing means to access said cavity and an opening for said butterfly as a means to exit said cavity after said duration of time.

16. The butterfly rearing kit of claim 5 additionally comprising:
said top wall having an open position with said fastener disengaged, and a closed position with said fastener engaged; and
said top wall in said open position providing means to access said cavity and an opening for said butterfly as a means to exit said cavity after said duration of time.

17. The butterfly rearing kit of claim 6 additionally comprising:
said top wall having an open position with said fastener disengaged, and a closed position with said fastener engaged; and
said top wall in said open position providing means to access said cavity and an opening for said butterfly as a means to exit said cavity after said duration of time.

18. The butterfly rearing kit of claim 7 additionally comprising:
said top wall having an open position with said fastener disengaged, and a closed position with said fastener engaged; and
said top wall in said open position providing means to access said cavity and an opening for said butterfly as a means to exit said cavity after said duration of time.

19. The butterfly rearing kit of claim 8 additionally comprising:
said top wall having an open position with said fastener disengaged, and a closed position with said fastener engaged; and
said top wall in said open position providing means to access said cavity and an opening for said butterfly as a means to exit said cavity after said duration of time.

20. The butterfly rearing kit of claim 9 additionally comprising:
said top wall having an open position with said fastener disengaged, and a closed position with said fastener engaged; and
said top wall in said open position providing means to access said cavity and an opening for said butterfly as a means to exit said cavity after said duration of time.
